(19) United States
(12) Patent Application Publication
(10) Pub. No.: US 2011/0283138 A1
(43) Pub. Date: Nov. 17, 2011

(54) Change Tracking and Management in Distributed Applications

(75) Inventors: Murali Sangubhatla, Kirkland, WA (US); Dmitry Sonkin, Redmond, WA (US); Alok Agarwal, San Francisco, CA (US); Edward K. Tremblay, Bellevue, WA (US)

(73) Assignee: Microsoft Corporation, Redmond, WA (US)

(21) Appl. No.: 12/777,275

(22) Filed: May 11, 2010

(51) Int. Cl. G06F 11/07; G06F 9/445; G06F 15/16

(52) U.S. Cl. 714/15; 709/202; 717/178; 714/49; 714/E11.024; 714/E11.023

(57) ABSTRACT

A monitoring and management system for distributed and interacting systems stores configuration settings after a successful installation or modification and compares values to the stored configuration settings. When a discrepancy is found, a messaging system may relay the information to a console where the issue may be dispositioned. In some cases, the configuration settings may be updated, while in other cases, the monitored setting may be restored to the stored configuration setting. A set of wizards or other user interface mechanisms may be used to restore the system to order.

### BACKGROUND

Applications and systems with many distributed and interacting parts can be difficult to manage. Changes to one part may affect another part, leading to problems in the application's operation and performance.

In order to manage many such systems, highly skilled and extensively trained administrators may coordinate changes and to troubleshoot problems. When the administrators are not fully aware of the adverse effects of a particular change, there may be extensive troubleshooting to correct a problem.

### SUMMARY

A monitoring and management system for distributed and interacting systems stores configuration settings after a successful installation or modification and compares values to the stored configuration settings. When a discrepancy is found, a messaging system may relay the information to a console where the issue may be dispositioned. In some cases, the configuration settings may be updated, while in other cases, the monitored setting may be restored to the stored configuration setting. A set of wizards or other user interface mechanisms may be used to restore the system to order.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with change management for distributed applications.

FIG. 2 is a flowchart illustration of an embodiment showing a method for installing applications on multiple hardware platforms.

FIG. 3 is a timeline illustration of an embodiment showing a method for monitoring parameters on a device.

FIG. 4 is a flowchart illustration of an embodiment showing a method for responding to a notification.

### DETAILED DESCRIPTION

A monitoring and management system for network computer systems may have monitoring agents on each device within the system and a centralized management tool. The monitoring agents may monitor specific parameters on a monitored device, which may include application parameters, operating system parameters, or other parameters. The management tool may receive alerts and present a user interface with one or more solutions to an alert. The solutions may include automated repairs to a particular problem.

The system may include a centralized settings database that may include parameter values to which the monitoring agents may compare a current or actual value. In some embodiments, portions of the centralized settings database may be cached on each device and may be available in the event the settings database may not be available.

The settings database may include installation settings for applications, which may be configured at the time the application was initially configured, as well as updates to the configuration settings that may occur over time. The settings database may also include configuration settings for operating system components on which the applications on the same device or other devices may depend.

When a monitoring agent determines a discrepancy in a monitored value, a notification may be generated and passed over the network to a management tool. The management tool may respond to the notification in several manners, depending on the circumstance. For example, the management tool may ignore the notification, automatically execute a repair routine, or present a set of options to a user. Each option may be an active repair, where a routine may be executed on the management device or the remote device to correct the problem, or an option may include a step by step set of instructions that may be performed by a user.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

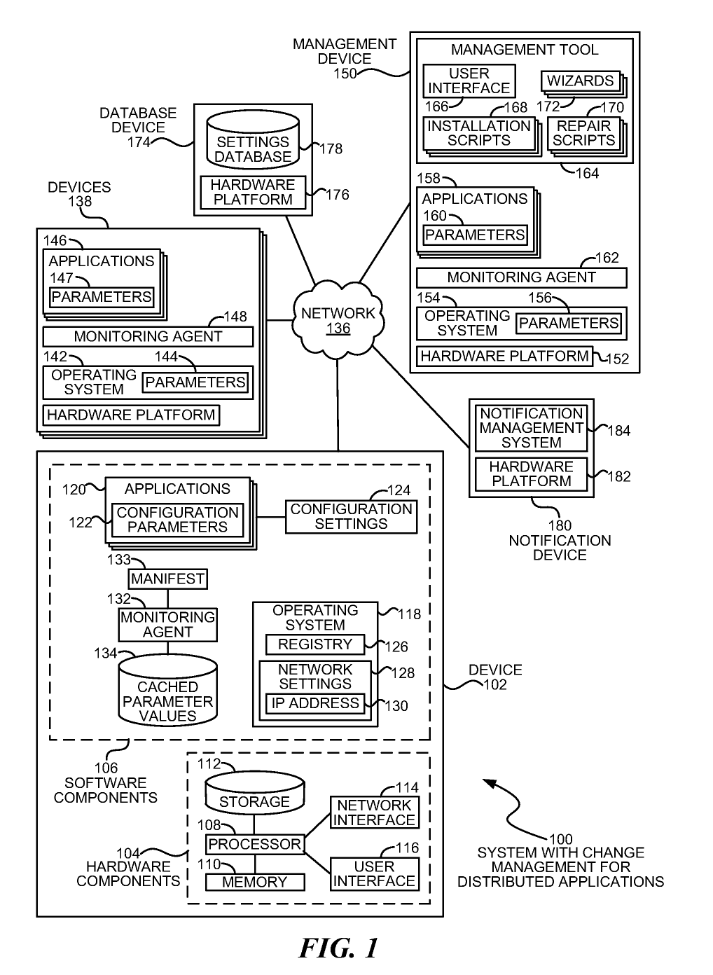

FIG. 1 is a diagram of an embodiment 100, showing a system with change management for distributed applications. Embodiment 100 is a simplified example of a set of devices in a network environment that may monitor and manage applications executing the various devices.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 is a simplified example of a network environment in which a distributed or interacting set of applications may function. Each of the applications may perform the same or a different function in the environment. In many cases, one application on one device may have a dependency or interaction with another application on another device.

Because of the interdependencies between applications and devices, a monitoring system may monitor settings that may affect a locally executing application as well as settings that may affect an application executing on another device. When a discrepancy is uncovered, a notification relating to the discrepancy may be transmitted to a management device that an administrator may use to correct the discrepancy.

In some cases, the monitoring system may find problems in a more efficient manner than would happen otherwise. The monitoring system may monitor two types of parameters: parameters that may adversely affect locally executing applications and parameters that may adversely affect applications executing on other devices.

Applications that execute on one device and interact with another device may not be readily aware of problems that may occur. For example, a first application may make an API call to a second application on another device. When the other device's machine name is inadvertently changed, the first application may repeatedly try to establish a connection but may otherwise function as normal. In some cases, the first application may continue for long periods of time without throwing an exception or raising an issue. The monitoring system may identify the changed machine name very quickly and lead to a resolution.

The monitored settings may be those settings that are defined during installation and further modified as the application is configured and operated. In some cases, the installation settings may be commonly defined for several applications that may interact.

In one use scenario, the set of applications may include a messaging application that operates on a first device and an authentication application on a second device. The authentication application may authenticate users and devices, and may apply group polices to the users and devices to allow access to various applications. In the scenario, the messaging application may communicate with the authentication application to permit or deny different levels of access to the messaging application.

When the two applications in the scenario are installed, an administrator may configure some common settings that may apply to both of the applications. The common settings may include both application settings and operating system settings. The application settings may configure the application to perform in certain manners, while the operating system settings may be settings such as network interface settings, device name, domain connections, and other operating system level settings.

In many cases, the operating system settings on one device may affect operations of an application on another device. For example, an application may be configured to communicate with another device to access an application programming interface provided by an application on the other device. Such a configuration may refer to the other device using an Internet Protocol (IP) address or a machine name. If the other device was misconfigured with a different IP address or the machine name was changed, the original application may not be able to find and communicate with the remote application.

The system defined in embodiment 100 may monitor the parameters and pass notifications to a management device where a management tool may assist an administrator in processing the notifications. In some cases, the management tool may automatically process the notification, while in other cases, the management tool may create several options and present the options on a user interface. Some or all of the options may have executable routines that may correct the cause of the notification.

The device 102 may represent a typical computer device, such as a desktop computer or server, having hardware components 104 and software components 106. In some embodiments, the device 102 may be a laptop computer, netbook computer, tablet computer, mobile telephone, handheld personal digital assistant, game console, network appliance, or any other computing device.

The architecture illustrated for device 102 may represent a typical architecture with hardware and software components; however, other architectures may be used to implement some or all of the distributed database system.

The hardware components 104 may include a processor 108, random access memory 110, and nonvolatile storage 112. The hardware components 104 may also include a network interface 114 and a user interface 116.

The software components 106 may include an operating system 118 on which various applications 120 may execute. The applications 120 may perform any type of function and may or may not interact with other applications that may operate on other devices. Each application 120 may have certain configuration parameters 122 that may or may not be monitored.

The application configuration parameters 122 may be any type of variable parameter that may be measured or queried. In some cases, the configuration parameters 122 may include values that may be obtained by querying the application 120 or otherwise interacting with the application 120. In other cases, the configuration parameters 122 may values that are output by the application 120 through some other mechanism.

In some cases, an application 120 may have a configuration file 124 that may contain configuration settings. The configuration file 124 may be read during startup or during operation of the application. In some cases, the configuration file 124 may be an installation file that contains settings used to initially configure the application 120 and may be updated or changed over time.

In many cases, an application 120 may make changes to an operating system 118 during installation and operation. For example, many applications may set various settings in a registry 126 that may be managed by the operating system 118. The registry settings may be used for parameters queried when an application 120 starts up or during the operation of the application.

The operating system 118 may contain several certificates 125 that may be used by the device 102 for authentication, encryption, decryption, or other functions. The certificates 125 may be used by various applications to authenticate against different devices and services and perform other interactions. The certificates 125 may be used during start up and from time to time during normal operation of an application.

The operating system 118 may also have other settings that may affect locally executing applications 120 or other devices or applications on other devices that may attempt to interact with the applications 120 on device 102. One example of such settings may be network settings 128, which may include an Internet Protocol (IP) address 130.

The network settings 128 may include many different parameters that may change how the device 102 may be accessed by other devices. For example, the network settings 128 may include a machine name that may be registered with a Domain Name Service (DNS). Other devices may access the device 102 may resolving a machine name against a DNS service to retrieve an IP address. When the machine name is changed, those devices that attempt to access the device 102 using the old machine name may fail to connect. Other network settings 128 may include domain connection information, which may include a domain name, domain passwords, and other information.

A monitoring agent 132 may monitor various configuration parameters and compare actual values for the parameters to cached parameter values 134. When a discrepancy is detected, the monitoring agent 132 may create a notification that may be transmitted to a management device 150.

The monitoring agent 132 may have a manifest 133 that may include the parameters to be monitored on the device 102. The manifest 133 may identify configuration parameters 122 that are internal to an application 120, configuration settings 124 that are used by the application 120 but may be external to the application, as well as settings in the registry 126 or other operating system 118 related parameters.

The monitoring agent 132 may monitor the status of the various certificates 125. The status may include the expiration date, chain of authentication, and other parameters.

The manifest 133 may include parameters that directly relate to how the local applications 120 are configured, but may also include settings that may affect how other applications communicate with or engage the various applications 120 on the device 102.

The device 102 may be an example of one of many devices connected to a network 136 and managed by a management device 150. Other devices 138 may have a hardware platform 140 similar to the hardware components 104, as well as an operating system 142 with various parameters 144. The devices 138 may have various applications 146 that may have various parameters 147 that configure the capabilities and behaviors of the applications 146.

The devices 138 may have a monitoring agent 148 that may monitor the various parameters related to the devices 138 and may operate in a similar manner as the monitoring agent 132 of device 102. In many embodiments, the monitoring agents 132 and 148 may be identical applications but may have different manifests and may monitor different parameters, depending on the specific applications executing on the particular device.

The management device 150 may be similar to the other devices 102 and 138 with the addition of a management tool 164. The management device 150 may have a hardware platform 152, an operating system 154 with various parameters 156, and multiple applications 158, each having a set of parameters 160. The management device 150 may also have a monitoring agent 162 that may monitor the various parameters associated with the management device 150.

The management tool 164 may receive the notifications created by the various monitoring agents 132, 148, and 162 and assist an administrator in correcting the underlying issues that brought about the notification.

In many cases, the management tool 164 may analyze a notification and generate a user interface 166 that may be displayed to an administrator. The user interface 166 may include a description of the notification and may also include one or more options for correcting whatever issue may be underlying the notification. As such, the management tool 164 may include a set of installation scripts 168, repair scripts 170, and wizards 172 that may be executed to correct a problem.

The management tool 164 may be used during an installation sequence to generate a set of common parameters and parameter values that may be shared by different applications on different devices. The installation scripts 168 may use the shared parameter values to configure different devices and applications.

The installation scripts 168 may be executed by the management device 150 in some circumstances and by other devices in other circumstances. In some cases, the installation scripts 168 may be modified or customized using various parameter values, then transmitted to and executed by one of the other devices 102 or 138.

The repair scripts 170 may be used by a management tool 164 to correct various problems that may be indicated by a notification. Like the installation scripts 168, the repair scripts 170 may be modified or customized using various parameter values, then transmitted to and executed by one of the other devices 102 or 138.

Some embodiments may have a database device 174 that may have a hardware platform 176 and a settings database 178. The settings database 178 may contain all of the monitored parameters and the normal or baseline value for each parameter. The various monitoring agents may compare the actual parameter values to the settings database 178 to determine a discrepancy.

The settings database 178 is illustrated as being on a separate device from the management tool 164. In some embodiments, both the settings database 178 and management tool 164 may operate on the same hardware platform.

In some embodiments, the monitoring agents may compare a parameter with a value retrieved from the settings database 178. In other embodiments, the monitoring agents may retrieve the parameter values from the settings database 178 and may store those values in a local cache, stored as the cached parameter values 134 in the example of device 102.

When the monitoring agents generate a notification, a notification device 180 may collect and transmit the notifications to the management device 150. The notification device 180 may have a hardware platform 182 similar to other hardware platforms of other devices, as well as a notification management system 184. The notification management system 184 may collect notifications from various devices and transmit the notifications to the management device 150 for consumption by the management tool 164. In some embodiments, the notification management system 184 may also perform other monitoring operations, such as monitoring performance, usage, and other factors.

The example of embodiment 100 may illustrate a set of devices that may interact. Because the devices may not be aware of the possible interactions with other devices, the management tool 164 may identify those interactions and determine which parameters may be monitored. The monitoring agents may be monitoring parameters on one device that may affect an application executing on another device.

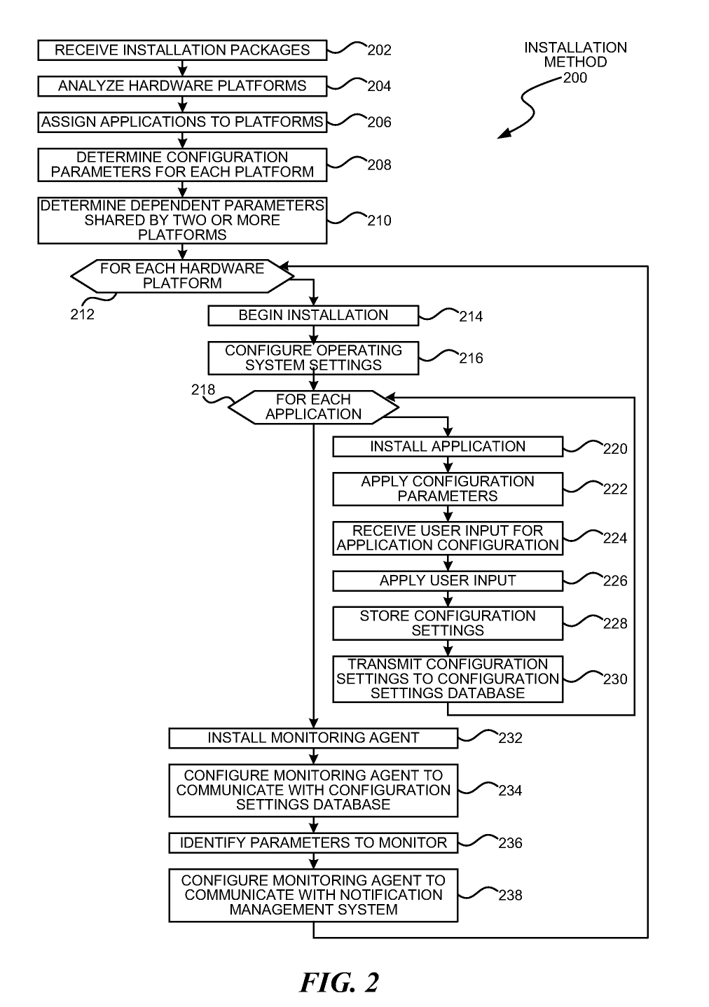

FIG. 2 is a flowchart illustration of an embodiment 200 showing a method for installing applications and monitoring agents on a set of hardware platforms. The operations of embodiment 200 may be performed by a management device, such as the management device 150 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 illustrates an example method by which a management tool may prepare several devices for installation, then launch the installation on the various devices. An overall configuration plan may be developed prior to any installation, and a set of configuration parameters may be defined for each device. Because the devices may interact, parameters on one device on which another device may depend may be identified and added to the first device's monitoring agent.

In block 202, the installation packages may be received. In some embodiments, the installation packages may be separate, independent installation packages for applications that may execute independently. In block 204, the hardware platforms may be analyzed and applications may be assigned to the hardware platforms in block 206. In some embodiments, each hardware platform may have a single application. In other embodiments, each hardware platform may execute two or more applications.

Based on the assignment of applications to the platforms in block 206, configuration parameters for each device may be defined in block 208. In a simple example, the names or IP addresses of each device may be assigned in block 208 and those names or IP addresses may be used as input to applications on other devices so that the other devices may be able to connect with and communicate with the first device.

In block 210, the dependent parameters shared by two or more hardware platforms may be identified. These parameters may be those that, if changed, may cause a problem with the dependent application or device. The dependent parameters may be later added to a monitoring agent.

Each hardware platform may be independently processed in block 212. In some embodiments, each hardware platform may be processed serially, while in other embodiments, two or more hardware platforms may be processed in parallel.

For each hardware platform in block 212, installation may begin in block 214.

The operating system settings may be configured in block 216. The settings in block 216 may be configuration settings for the device that may connect to a specific network or domain, and to function in a specific manner. The settings in block 216 may add or remove certain features to an operating system and configure the features to accept the applications and communicate on a network.

For each application assigned to the hardware platform in block 218, the application may be installed in block 220. The configuration parameters may be applied to the application in block 222. The configuration parameters may be the general settings defined in block 204 through 208. In some embodiments, the installation process may present a user interface to collect data, and such data may be received in block 224. The collected data may be specific configuration parameters for the application. The user input may be applied in block 226.

The configuration settings for the application may be stored in block 228 and may be transmitted to a configuration settings database in block 230. The configuration settings may be used by the monitoring agent to determine when a parameter has changed.

After installing and configuring each application in block 218, the monitoring agent may be installed in block 232. The monitoring agent may be configured to communicate with the configurations settings database in block 234.

The parameters to monitor may be identified in block 236. The parameters may include configuration parameters for each of the applications, as well as any dependent parameters on which other applications on other devices may depend. The parameters may include operating system settings, including network configurations, as well as registry settings that may be configured for the operating system or the applications. The parameters may include application configuration settings as well.

The monitoring agent may be configured in block 238 to communicate with the notification management system, which may receive notifications and route the notifications to a management tool.

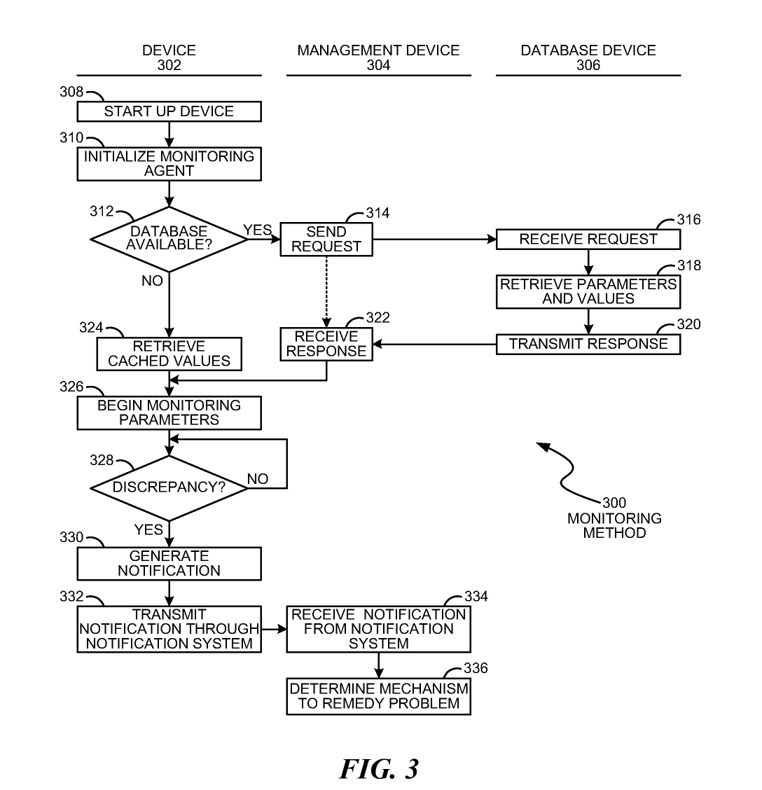

FIG. 3 is a timeline illustration of an embodiment 300 showing the interaction of a device 302, a management device 304, and a database device 306. The operations illustrated may be one method of interacting between a device with a monitoring agent, such as device 102, a management device, such as management device 150, and a database device, such as database device 174 of embodiment 100. The operations of the device 302 are illustrated in the left hand column, the operations of the management device 304 are illustrated in the center column, and the operations of the database device 306 are illustrated in the right hand column.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 illustrates a simplified exchange between a device 302, a management device 304, and a database device 306. The exchange illustrates how a device with a monitoring agent may start up, gather parameters to monitor, and monitors the parameters. When a current parameter value does not correlate with a stored parameter value, a notification may be transmitted and the management device 304 may remedy the problem.

In block 308, the device 302 may start up. The monitoring agent may be initialized in block 310. If the database device is available in block 312, a request may be sent in block 314 to the database device 306. The database device 306 may receive the request in block 316, retrieve parameters and values in block 318, and transmit a response in block 320. The response may be received by the device 302 in block 322.

In some embodiments, a monitoring agent may transmit a request for those parameters assigned to be monitored on the device 302. In such an embodiment, the request in block 314 may include an identifier for the device 302.

In other embodiments, the monitoring agent may transmit a request for all parameters in the database. After receiving all of the parameters in block 322, the monitoring agent may filter those parameters assigned to the device 302.

In some cases, the database may not be available in block 312. When the database is not available, the values may be retrieved from a cache in block 324.

After gathering all of the parameters to monitor, the monitoring may begin in block 326. Some parameters may be monitored very frequently while other parameters may be monitored very infrequently. For example, some parameters may have an effect only during startup operations of the device or of an application. Such parameters may be examined once and may not be examined until the device or application is restarted.

Other parameters may be monitored on different frequencies. The frequency may depend on how sensitive the parameter might be to failure. For example, a parameter that may cause severe problems may be monitored more frequently than a parameter that may cause a minor inconvenience. Similarly, a parameter that takes a lot of processing power to retrieve may be accessed less frequently than a parameter that may be accessed easily.

In some cases, the monitoring agent may have a set of scripts, application programming interface calls, or other specialized mechanisms for accessing a parameter. In some cases, the monitoring agent may have generalized capabilities, such as the capability to examine a text-based configuration file. In such a case, the monitoring agent may be supplied a script that may identify a specific parameter from a text-based configuration file.

Until a discrepancy is found in block 328 between an actual value and a stored value of a parameter, the process may loop through block 328.

When a discrepancy is found in block 328, a notification may be generated in block 330 and transmitted to the management device 304 in block 332. The notification may include information that may be useful to the management device, such as a description of the parameter, the expected value, the actual value, and other diagnostic information.

The notification may be received by the management device 304 in block 334. The management device 304 may determine a mechanism to remedy the problem in block 336. A more detailed example of the operations of block 336 may be found in embodiment 400.

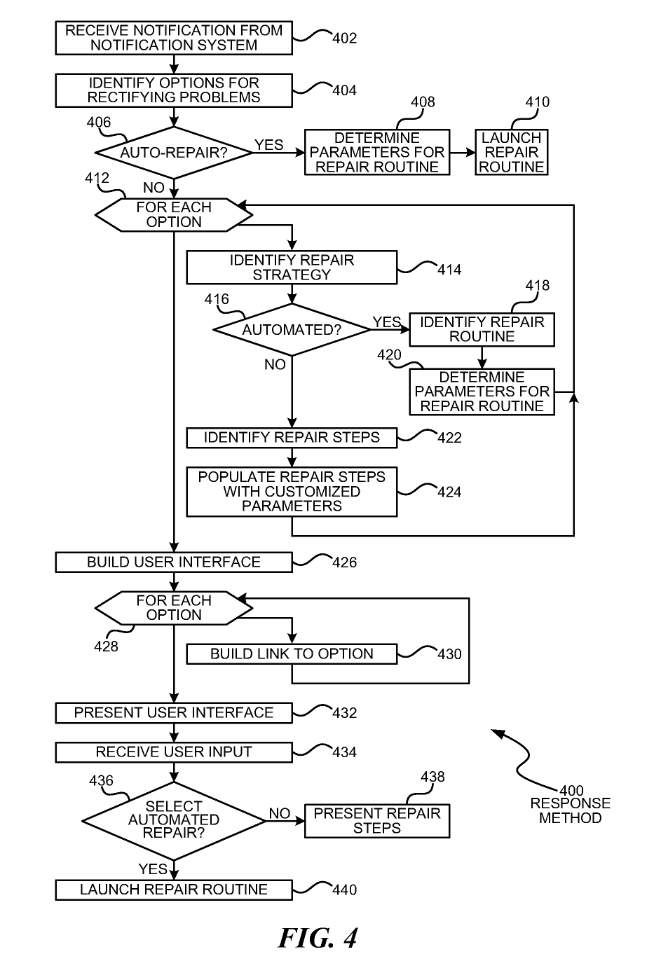

FIG. 4 is a flowchart illustration of an embodiment 400 showing a method for responding to a notification. The operations of embodiment 400 may be one method that may be performed by a management device, such as the management device 304 of embodiment 300.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 illustrates one method by which a management device may determine how to respond to a notification. In many cases, the management device may create a set of options and prepare routines to be executed when a user selects one of the options.

A notification may be receive from a notification system in block 402.

Based on the notification, a set of options may be identified for rectifying the problem that originated the notification.

In some cases, auto-repair may be attempted in block 406. Auto-repair may be an attempt to correct the underlying issue without administrator involvement. Auto-repair may be performed by executing a routine, and the parameters for the repair routine may be determined in block 408 and launched in block 410.

The repair routine may be any type of executable, including binary executable, scripts, parameters passed to an existing executable, or other mechanism. In some cases, the repair routine may be executed by a management device, while in other cases, the repair routine may be executed by the device on which the notification originated. In still other cases, the repair routine may be executed on a third device.

If auto-repair is not used in block 406, each option may be processed in block 412.

For each option in block 412, the repair strategy may be identified in block 414. If the repair may be an automated repair in block 416, the repair routine may be identified in block 418 and parameters for the repair routine may be determined in block 420.

If the repair is not automated in block 416, the repair may be a manual repair that may be performed by an administrator. The steps of the repair may be identified in block 422 and populated with customized parameters in block 424. The customized parameters may make the repair steps specific to the incident. For example, a set of repair steps for resetting a device name may be populated with the device's description, current name, correct name, and any steps that an administrator may use to change the device name.

After determining all of the options in block 412, a user interface may be built in block 426. For each option in block 428, a link to the option may be created in block 430, and the user interface may be presented in block 432.

A user may select one of the repair options in block 434. If the repair is not automated in block 436, the user may be presented with a set of repair steps to perform. If the repair is automated in block 436, a repair routine may be launched in block 440.

One of the options may be to update the parameter database to match the actual value of the parameter. Such an option may essentially ignore the notification and may prevent future notifications from being created.

Another one of the options may be to reset the parameter to the stored value. Such an option may undo any change that may have caused the parameter to be changed in the first place. With some applications, the application may be reinstalled to reset all of the parameters. With other applications, the parameters may be individually changed or updated using a repair script.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a deployed settings database comprising values for parameters;
a monitoring agent that:
monitors a first parameter of said parameters;
determines a current actual value for said first parameter;
compares said current actual value to a first value obtained from said deployed settings database to determine a discrepancy between said current actual value and said first value;
generates a notification for said first parameter; and
transmits said notification to a management tool;
said management tool that:
receives said notification; and
presents a first option to a user to reset said first parameter to said first value.

2. The system of claim 1, said management tool that further:
presents a second option to said user to reset said first value to said current actual value.

3. The system of claim 2, said management tool that comprises:
a set of executable routines, a first routine of said executable routines capable of performing said first option, and a second routine of said executable routines capable of performing said second option.

4. The system of claim 3, said monitoring agent operating on a first device, and said management tool operating on a second device.

5. The system of claim 4, said monitoring agent comprising:
a local cache comprising at least a portion of said values for said parameters from said deployed settings database.

6. The system of claim 2, said second routine being further capable of updating said deployed settings database with said current actual value.

7. The system of claim 1, said deployed settings database comprising settings determined at installation of an object that set said first parameter.

8. The system of claim 7, said object being an application.

9. The system of claim 7, said object being an operating system component.

10. The system of claim 9, said object being a network connection setting.

11. The system of claim 7, said object being a certificate.

12. The system of claim 7, said deployed settings database comprising settings determined prior to said installation.

13. A method comprising:
installing an object on a first device, said installing comprising configuring at least one operating system component;
storing a first parameter in a deployed settings database as a first stored parameter, said first parameter being a configuration parameter for said first object;
installing a monitoring agent that
monitors said first parameter on said first object to determine a first current value and comparing said first current value to said first stored parameter to determine a discrepancy;
creates a notification comprising said discrepancy; and
transmits said notification to a management console;
receiving said notification from said monitoring agent;
identifying a plurality of options based on said notification, each of said options being a method for rectifying said discrepancy between said first current value and said stored parameter; and
presenting said plurality of options to a user on a user interface.

14. The method of claim 13, at least one of said plurality of options having a link to an executable routine configured to perform said rectifying.

15. The method of claim 14, said rectifying comprising resetting said first parameter on said object to said first stored parameter.

16. The method of claim 14, said rectifying comprising setting said first stored parameter to said first current value.

17. The method of claim 14, said executable routine being executed on said first device, said method being performed on a second device.

18. A system comprising:
a plurality of computing devices, each of said computing devices having a processor;
a plurality of applications, each of said plurality of applications executing on a different one of said plurality of computing devices, each of said plurality of applications having a dependency on a different one of said plurality of applications;
a settings database comprising parameter values for each of said plurality of applications, said parameter values comprising at least one configuration parameter for one of said applications, said parameter values comprising at least one operating system configuration value on which one of said plurality of applications depends;
for each of said plurality of computing devices, a monitoring agent that:
determines a subset of parameters stored in said settings database to monitor;
monitors each of said parameters in said subset of said parameters; and
transmits a notification when one of said parameters does not match a corresponding parameter value in said settings database;
a management tool comprising a plurality of executable routines configured to respond to said notification and repair said corresponding parameter value.

19. The system of claim 18, said management tool further comprising a wizard user interface comprising a plurality of steps configured to perform said repair.

20. The system of claim 18, said operating system configuration value being an Internet Protocol address.
